(19) United States
(12) Patent Application Publication
(10) Pub. No.: US 2021/0258503 A1
(43) Pub. Date: Aug. 19, 2021

(54) SYSTEMS AND METHODS FOR TRACKING A VIEWING AREA OF A CAMERA DEVICE

(71) Applicant: Pelco, Inc., Fresno, CA (US)

(72) Inventor: Mathew STAPLES, Fort Collins, CO (US)

(21) Appl. No.: 16/972,308

(22) PCT Filed: May 15, 2019
(86) PCT No.: PCT/US19/32362

§ 371 Date: Dec. 4, 2020

Related U.S. Application Data
(60) Provisional application No. 62/684,307, filed on Jun. 13, 2018.

(51) Int. Cl. H04N 5/232; H04N 7/18

(52) U.S. Cl. CPC H04N 5/232945; H04N 5/23238; H04N 7/181; H04N 5/23296; H04N 5/23299

(57) ABSTRACT

A method includes receiving video data from at least one camera device on a remote video management system (VMS) that is communicatively coupled to the at least one camera device. A first video stream corresponding to a panoramic view of imagery associated with the video data, and a second video stream corresponding to an immersive view of select portions of the first video stream, are generated. The first video stream is presented in a first respective viewing area of a remote display device that is communicatively coupled to the remote VMS, and the second video stream is presented in a second respective viewing area of the remote display device. A viewing area of the immersive view is controlled, and an overlay is provided on the presented first video stream to indicate the viewing area of the immersive view on the panoramic view.

### CROSS-REFERENCE TO RELATED APPLICATIONS

The present application claims priority to U.S. Provisional Application Ser. No. 62/684,307 which was filed on Jun. 13, 2018 (CLO-0182-US-PSP) and is incorporated by reference herein in its entirety.

### FIELD

This disclosure relates generally to camera devices, and more particularly, to systems and methods related to tracking a viewing area of a camera device.

### BACKGROUND

Cameras are used in a variety of applications. One example application is in surveillance applications in which cameras are used to monitor indoor and outdoor locations. Networks of cameras may be used to monitor a given area, such as the internal and external portion (e.g., a room, or entrance) of a commercial building.

### SUMMARY

Described herein are systems and methods related to tracking a viewing area of a camera device (or camera), and providing the ability to indicate a current viewing area of an immersive view within an associated panoramic view. More particularly, in one aspect, a method according to the disclosure includes receiving video data from at least one camera device on a remote video management system (VMS) that is communicatively coupled to the at least one camera device. A first video stream corresponding to a panoramic view of imagery associated with the video data, and a second video stream corresponding to an immersive view of select portions of the first video stream, are generated. The first video stream is presented in a first respective viewing area of a remote display device that is communicatively coupled to the remote VMS, and the second video stream is presented in a second respective viewing area of the remote display device. A viewing area of the immersive view is controlled, and an overlay is provided on the presented first video stream to indicate (or track) the viewing area of the immersive view on the panoramic view. In embodiments, the viewing area of the immersive view has an associated pan, tilt and/or zoom position. In embodiments, the pan, tilt and/or zoom position corresponds to a digital pan, tilt and/or zoom position. Additionally, in embodiments the pan, tilt and/or zoom position corresponds to an optical pan, tilt and/or zoom position (e.g., of the at least one camera device). In embodiments, a position of the immersive view is continuously tracked within the panoramic view using the overlay.

In embodiments, the first video stream and the second video stream are generated from one video stream (here, one video stream of the video data received from the at least one camera device). The one video stream may be used to generate two different projected views (here, the panoramic and immersive views). In one example implementation, the different projected views may be turned into new data streams and sent to separate viewers (e.g., separate viewing areas of a remote display device, or separate remote display devices).

The method may include one or more of the following features either individually or in combination with other features. One or more objects of interest may be identified in the second video stream. Controlling the viewing area of the immersive view may include controlling the viewing area of the immersive view to focus on the identified objects of interest. One or more properties associated with the overlay may be user configurable. The properties may include a shape and/or a color of the overlay. The overlay may correspond to (or include) a line surrounding edges (or boundaries) of the viewing area of the immersive view. The overlay may be provided by mapping points around a perimeter of the immersive view into the panoramic view, and generating the overlay on the presented first video stream according to the mapped points.

The video data may be received by the remote VMS in one or more video streams. The video data may correspond to (or include) two-dimensional (2-D) video data. Generating the first video stream may include copying the 2-D video data onto respective faces of a three-dimensional (3-D) texture cube. Additionally, generating the first video stream may include projecting the 3-D texture cube onto a viewing surface, where a viewer's “eye” is placed at a center portion of the 3-D texture cube. Controlling the viewing area of the immersive view may include adjusting pan, tilt and/or zoom parameters associated with the immersive view, for example, to focus on identified objects of interest.

In embodiments, the at least one camera may include a wide field of view camera, for example, with a fixed viewing area. As one example, the wide field of view camera may include a wide field of view camera from Pelco, Inc., such as an Optera™ multi-sensor panoramic camera. In embodiments, the at least one camera may also include a pan-tilt-zoom (PTZ) camera. As one example, the PTZ camera may include a PTZ camera from Pelco, Inc., such as a Spectra™ PTZ camera. In embodiments, the first video stream may be generated from video data associated with the wide field of view camera. Additionally, in embodiments the second video stream may be generated from video data associated with the PTZ camera.

In embodiments, the systems and methods disclosed herein may be used in multi-camera (or linked-camera) tracking applications, for example, in which: at least one physical PTZ camera is linked to at least one wide field of view camera such that the at least one PTZ camera can be commanded to look at a point (or area) within a shared field of view of the at least one wide field of view camera. The at least one physical PTZ camera and the at least one wide field of view camera may correspond to the claimed at least one camera device. In embodiments, the techniques disclosed herein, for example, to track a current immersive viewing area, may be used to show an approximate viewing area of the at least one PTZ camera within a panoramic view of the at least one wide field of view camera to which it is linked with. In embodiments, such transformation may require knowledge of the linked-camera calibration info.

In embodiments, the systems and methods disclosed herein may also be used in multi-camera (or linked-camera) tracking applications, for example, in which: a video stream is processed in at least one first camera device to identify actionable motion objects (AMOs), the at least one first camera device is caused to transmit metadata associated with the identified AMOs to at least one second camera device, and a viewing area of the at least one second camera device is dynamically controlled in response to the metadata to enable the at least one second camera to track and focus on at least one of the identified AMOs. The AMOs may, for example, correspond to one or more persons or vehicles. In embodiments, dynamically controlling the viewing area of the at least one second camera may include dynamically controlling PTZ motion of the at least one second camera. The at least one first camera may be (or include) a wide field of view camera. In embodiments, the wide field of view camera may have a fixed viewing area. The at least one second camera may be (or include) a PTZ camera.

The at least one of the identified AMOs tracked and focused on by the at least one second camera may correspond to a physically largest object of the identified AMOs. The at least one of the identified AMOs tracked and focused on by the at least one second camera may correspond to a fastest moving object of the identified AMOs. The at least one of the identified AMOs tracked and focused on by the at least one second camera may correspond to a closest object of the identified AMOs to the at least one second camera. The at least one of the identified AMOs tracked and focused on by the at least one second camera may correspond to a farthest object of the identified AMOs to the at least one second camera. It is understood that the at least one of the identified AMOs tracked and focused on by the at least one second camera is not limited to the above-described object types. Rather, the at least one second camera may track and focus on identified AMOs based on other object characteristics, such as type (car, person, etc.), color, etc.

Additional aspects of multi-camera tracking applications are described, for example, in U.S. Non-Provisional application Ser. No. 16/366,212 entitled “Method of Aligning Two Separated Cameras Matching Points in the View” and U.S. Non-Provisional application Ser. No. 16/366,382 entitled “Multi-Camera Tracking,” which are assigned to the assignee of the present disclosure and incorporated herein by reference in their entirety.

### BRIEF DESCRIPTION OF THE DRAWINGS

The foregoing features of the disclosure, as well as the disclosure itself may be more fully understood from the following detailed description of the drawings, in which:

FIG. 1 shows an example video surveillance system (or VSS) in accordance with embodiments of the disclosure;

FIG. 2 is a flowchart illustrating an example method for tracking a viewing area of a camera device;

FIG. 3 is a flowchart illustrating an example method for generating first and second video streams corresponding to panoramic and immersive views;

FIG. 4 shows an example scene captured by a video surveillance camera device without overlay features according to the disclosure enabled;

FIG. 5 shows an example scene captured by a video surveillance camera device with overlay features according to the disclosure enabled;

FIG. 6 shows another example scene captured by a video surveillance camera device with overlay features according to the disclosure enabled;

FIG. 7 shows a further example scene captured by a video surveillance camera device with overlay features according to the disclosure enabled;

FIG. 8 shows another example scene captured by a video surveillance camera device with overlay features according to the disclosure enabled; and

FIG. 9 shows an example of a computer device (or system) in accordance with embodiments of the disclosure.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

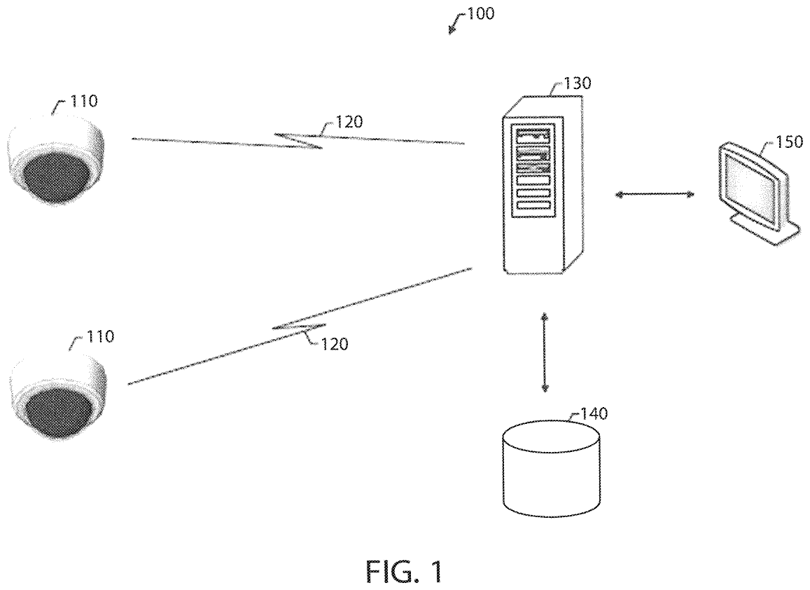

Referring to FIG. 1, an example video surveillance system 100 according to the disclosure is shown including at least one camera device 110 (here, two cameras 110) and at least one remote video management system (VMS) 130 (here, one VMS 130). The at least one camera 110 may be positioned to monitor one or more areas interior to or exterior from a building (e.g., a commercial building) or other structure to which the at least one camera 110 is coupled. Additionally, the at least one VMS 130 may be configured to receive video data from the at least one camera 110. In embodiments, the at least one camera 110 is communicatively coupled to the at least one VMS 130 through a communications network, such as, a local area network, a wide area network, a combination thereof, or the like. Additionally, in embodiments the at least one camera 110 is communicatively coupled to the at least one VMS 130 through a wired or wireless link, such as link 120 shown.

The VMS 130 is communicatively coupled to at least one memory device 140 (here, one memory device 140) (e.g., a database) and to a remote display device 150 (e.g., a computer monitor) in the example embodiment shown. The at least one memory device 140 may be configured to store video data received from the at least one camera 110. Additionally, the VMS 130 may be configured to present select camera video data, and associated information, via the remote display device 150, for example, for viewing by a user (e.g., security personnel monitoring the building to which the at least one camera 110 is coupled). In embodiments, the VMS 130 and/or the remote display device 150 may be communicatively coupled to a user input device (e.g., a keyboard) (not shown). In embodiments, a user may select the camera video data to be presented on the remote display device 150 via the user input device. For example, the user may select a particular camera of the at least one camera 110 for which the user wants to view video data. Additionally, the user may select a particular area monitored by the video surveillance system 100 for which the user wants to view video data. For example, the particular area may correspond to an entrance of a building which the video surveillance system 100 is configured to monitor. In embodiments, the particular area may be monitored by one or more cameras of the at least one camera 110.

In some embodiments, the at least one memory device 140 is a memory device of the VMS 130. In other embodiments, the at least one memory device 140 is an external memory device, as shown. In some embodiments, the at least one memory device 140 includes a plurality of memory devices. For example, in some embodiments the at least one memory device 140 includes at least a first memory device and a second memory device. The first memory device may be configured to store a first portion of video data received from the at least one camera device 140, for example, a video stream of the video data. Additionally, the second memory device may be configured to store a second portion of video data received from the at least one camera device 140, for example, a metadata stream of the video data. In embodiments, the first and second memory devices are located at a same geographical location. Additionally, in embodiments the first and second memory devices are located at different geographical locations, for example, to provide an additional layer of security for the video data stored on the first and second memory devices.

The at least one VMS 130 to which the at least one memory device 140 is communicatively coupled may include a computer device, e.g., a personal computer, a laptop, a server, a tablet, a handheld device, etc., or a computing device having a processor and a memory with computer code instructions stored thereon. In embodiments, the computer or computing device may be a local device, for example, on the premises of the building which the at least one camera 110 is positioned to monitor, or a remote device, for example, a cloud-based device.

In embodiments, the at least one camera 110 includes at least one processor (not shown) which is configured to provide a number of functions. For example, the camera processor may perform image processing, such as motion detection, on video streams captured by the at least one camera 110. In some embodiments, the at least one camera 110 is configured to process a video stream captured by the at least one camera 110 on the at least one camera 110 to identify one or more objects of interests (e.g., people) in the video stream. In other embodiments, the remote VMS 130 may be configured to identify the objects of interest. In embodiments, the objects of interest are user configured objects of interest.

In some embodiments, the video streams captured by the at least one camera device 100 may be stored on a memory device associated with the at least one camera 110 prior to and/or after the processing by the at least one camera 110 (in embodiments in which the camera 110 performs processing). In some embodiments, the memory device associated with the at least one camera 110 may be a memory device of the at least one camera 110 (e.g., EEPROM). In other embodiments, the memory device associated with the at least one camera 110 may be an external memory device (e.g., a microSDHC card).

Additional aspects of video surveillance systems in accordance with various embodiments of the disclosure are discussed further in connection with figures below.

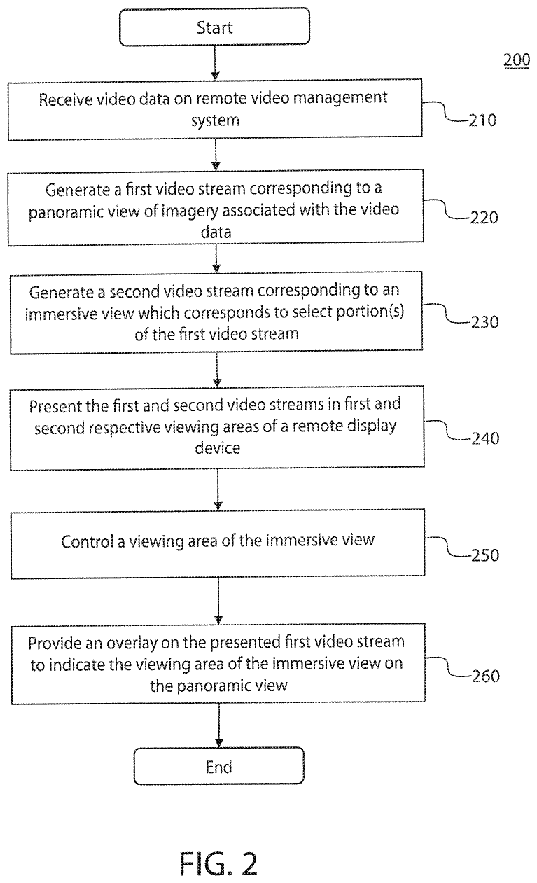

Referring to FIG. 2, a flowchart (or flow diagram) 200 is shown. Rectangular elements (typified by element 210), as may be referred to herein as “processing blocks,” may represent computer software instructions or groups of instructions. The processing blocks can represent steps performed by functionally equivalent circuits such as a digital signal processor circuit or an application specific integrated circuit (ASIC).

The flowchart 200 does not depict the syntax of any particular programming language. Rather, the flowchart 200 illustrates the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied. Thus, unless otherwise stated, the blocks described below are unordered; meaning that, when possible, the blocks can be performed in any convenient or desirable order including that sequential blocks can be performed simultaneously and vice versa.

Referring to FIG. 2, the flowchart 200 illustrates an example method for tracking a viewing area of a camera device that can be implemented, for example, using video surveillance system 100 shown in FIG. 1.

As illustrated in FIG. 2, the method begins at block 210, where video data from at least one camera device (e.g., 110, shown in FIG. 1) is received on a remote video management system (VMS) (e.g., 130, shown in FIG. 1). In embodiments, the remote VMS is communicatively coupled to the at least one camera device through a communications network, and/or through a wired or wireless link (e.g., 120, shown in FIG. 1).

In embodiments, the video data (e.g., “raw” two-dimensional (2-D video data)) is received from the at least one camera device in one or more video streams. Depending on the model and mode of the at least one camera (which may include one or more image sensors), for example, there can be a predetermined number of separate video streams (e.g., up to five). In embodiments, the number of streams is unrelated to the number of sensors (e.g., four) in the at least one camera. Rather, the number of streams, and the layout of video data within each stream's video frames, may be related to how the video data is used to generate a first video stream at block 220.

At block 220, the remote VMS generates a first video stream corresponding to a panoramic view of imagery associated with the video data. In embodiments, the first video stream is generated by copying the imagery associated with the video data (e.g., 2-D video data) onto respective faces of a three-dimensional (3-D) texture cube, and projecting the 3-D texture cube onto a viewing surface, where a viewer's “eye” is placed at a center portion of the 3-D texture cube. A viewer looking outwards from the center “sees” the video data on the inside of the 3-D texture cube. Different types of views can be generating by changing the view's 3D Projection. In embodiments, the panoramic view has an associated viewing area (e.g., 180°, 270°, and) 360°. In embodiments, the viewing area is related to a number of sensors (e.g., CMOS sensors) in the at least one camera device. For example, at least one camera device with four sensors may have a field of view of 270°, and the viewing area of the panoramic view may also be 270°.

In embodiments, the use of a 3-D texture cube is overlay specific (i.e., specific to embodiments in which an overlay is provided in a video stream to indicate a viewing area, as discussed further below in connection with block 260). The 3-D texture cube is one example tool for performing a geographic transform (or projection) between raw, 2-D video data from the camera, for example, and the various 2-D views. The 3-D texture cube provides an intermediate 3-D model of the data that is easier to project into different 2-D views using standard 3-D graphics techniques (e.g., as implemented by OpenGL or Direct3D). The net result is a 2-D to 2-D geometric transform, which does not necessarily have to be accomplished via an intermediate 3-D model.

At block 230, the remote VMS generates a second video stream corresponding to an immersive view of select portions of the first video stream. In embodiments, the select portions of the first video stream correspond to portions of the first video stream having an object of interest (e.g., as may be identified at block 250, as will be discussed below). In embodiments, the immersive view may be generated in a same (or similar) way as the panoramic view, with the panoramic and immersive views corresponding to two different geometric transforms of the same raw input data. The panoramic view includes the full (or total) field of view of the camera, and the immersive view includes a sub-set of the total field of view.

At block 240, the first video stream is presented in a first respective viewing area of a remote display device (e.g., 150, shown in FIG. 1) that is communicatively coupled to the remote VMS. Additionally, at block 240 the second video stream is presented in a second respective viewing area of the remote display device.

In embodiments, the panoramic view depicted by the first video stream uses a map projection to show all (or substantially all) of the imagery associated with the video data at once in the first viewing area of the remote display device, for example, similar to how a 2-D map of the Earth shows the entire globe in a single view. Additionally, in embodiments the immersive view depicted by the second video stream uses a relatively “simple” perspective projection.

In embodiments, the immersive projection is “relatively simple” in that it is a direct use of the standard projective transform model used by most 3-D graphics applications. In that model, the view window can be thought of as a transparent window at some distance in front of the viewer, through which you can see the “world”. The “world” in this model is the video data that has been copied onto the inside of the 3-D texture cube. The cube surrounds both the viewer and the view window, so that when looking through the view window, you see a portion of the inside of the texture cube. Note that in embodiments the edges of the cube are seamless, so the fact that it is a cube and not a sphere is hidden from to the viewer. Zoom in or out is achieved by moving the window away from or toward the viewer, thereby narrowing or widening the window's field of view respectively. Pan and tilt are achieved by keeping the center of the window at a fixed radius from the viewer while and moving the window left/right/up/down around that radius. It follows that the “simple” part about this projection is that it is just a matter of calculating the angle between the viewer's eye and each point in the view window, and then directly using those two angles to look up the corresponding color value from the 3-D texture cube. In embodiments, no additional warping is applied. Whereas with the panoramic transform, the mapping between the perspective view angles and the texture cube may be more involved and non-linear.

At block 250, a viewing area of the immersive view is controlled, for example, to focus on one or more identified objects of interest. In embodiments, the viewing area of the immersive view is controlled by adjusting pan, tilt and/or zoom parameters associated with the immersive view to focus on the identified objects of interest. By adjusting the pan, tilt and zoom parameters of the immersive view, for example, the immersive view can zoom in and out and look at the surrounding 3-D data from substantially any angle, as if there were a virtual PTZ camera placed at the center of the 3-D cube discussed above in connection with block 220.

In one example configuration, one or more objects are identified in the second video stream, and the viewing area of the immersive view is controlled to focus on these objects. In some embodiments, the objects may be identified (or selected) by a user, for example, through a user input device that is communicatively coupled to the remote VMS. Additionally, in some embodiments the objects may be identified by the remote VMS. For example, in embodiments the objects may correspond to motion objects (e.g., moving people) in the second video stream, and the remote VMS may be able to identify the motion objects by monitoring video frames of the second video stream for motion. In embodiments, the objects may also correspond to stationary objects (e.g., a stopped vehicle, or an abandoned package). It is understood that the controlling of the viewing area (e.g., digital PTZ control) may be done automatically (e.g., in response to the motion tracking discussed above) in some embodiments, or by a human operator in other embodiments.

At block 260, an overlay is provided on the presented first video stream to indicate the viewing area of the immersive view on the panoramic view. As discussed above, the first video stream corresponds to a panoramic view of imagery associated with imagery received from the at least one camera, and is presented in a first viewing area of the remote display device. The overlay can move or change in size, shape or dimension on the panoramic view as the viewing area of the immersive view changes under for example automatic control or by a human operator. The overlay can be provided, for example, by calculating or determining the shape of the overlay based on the immersive view, and rendering the overlay on a corresponding mapped position on the panoramic view using a computer graphic rendering application (e.g., OpenGL, Direct3D, and so forth).

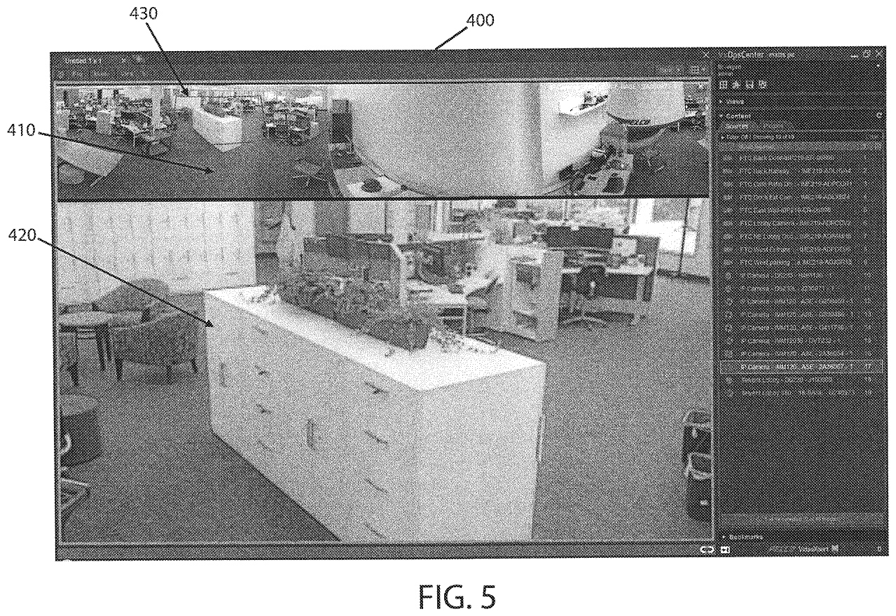

In embodiments, the overlay corresponds to a line surrounding edges (or a boundary) of the viewing area of the immersive view (or a perimeter of the immersive area's field of view), for example, as shown in FIG. 5, as will be discussed below. It is understood that the overlay may take a variety of other forms. In embodiments, substantially any other graphical representation of the viewing area of the immersive view may be found suitable, e.g., shading the area with a semi-transparent color.

In embodiments, one or more properties associated with the overlay are user configurable. For example, in embodiments the overlay properties include a shape (e.g., square, rectangle, etc.) and/or a color (e.g., red, blue, white, etc.) of the overlay, and a user may configure the shape and/or color of the overlay, for example, through a user interface of the remote display device. Other attributes of the overlay (e.g., thickness, dashed or dotted lines) may also be configurable.

It is understood that while one or more blocks of the method are described as being performed by the remote VMS, in some embodiments these blocks (e.g., 220, 230) may be performed by the at least one camera device, alone or in combination with the remote VMS (and/or other devices of the video surveillance system). For example, video data generated by the at least one camera device may be processed by the at least one cameras device, alone or in combination with the remote VMS (and/or other devices of the video surveillance system), to generate the above-described first and second video streams at blocks 220 and 230. Additionally, in some embodiments the at least one camera device may identify objects of interest in the video data (e.g., at block 250).

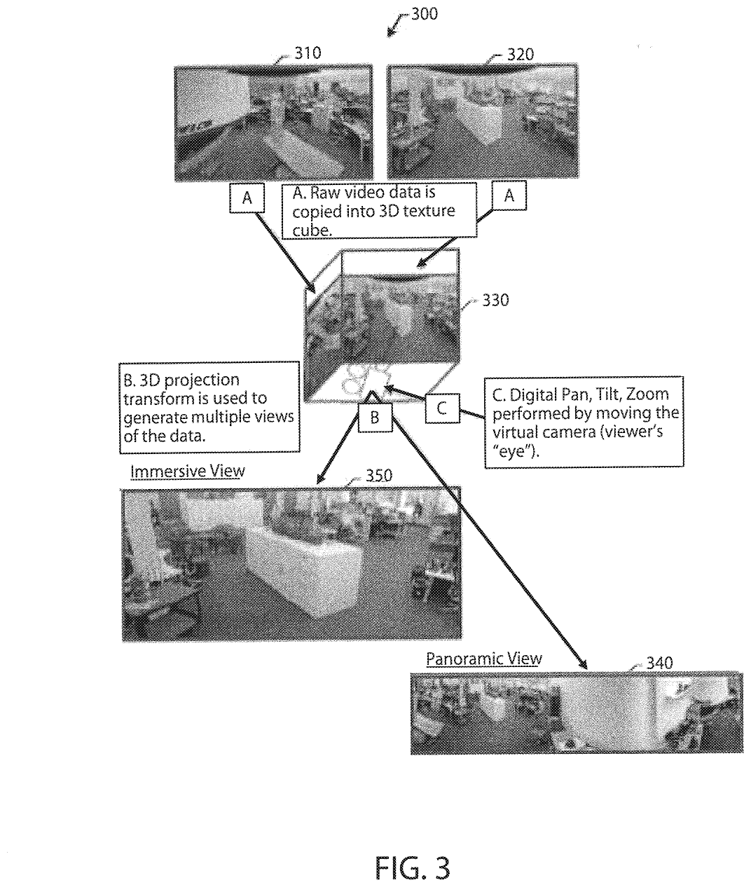

Referring to FIG. 3, an example method 300 for generating first and second video streams corresponding to panoramic and immersive views (e.g., at blocks 220 and 230 of the method shown in FIG. 2) is shown.

In a first portion of the illustrated method 300, video data 310, 320 from at least one camera device (e.g., 110, shown in FIG. 1) is copied into a 3-D texture cube 330. Additionally, in a second portion of method 300, a 3-D projection transform is used to generate multiple views of the video data, as illustrated by panoramic view 340 and immersive view 350 in the example embodiment shown. In embodiments, the panoramic view 340 corresponds to a first generated video stream (e.g., at block 220 of the method shown in FIG. 2). More particularly, the first video stream corresponds to a panoramic view of imagery associated with the video data (here, video data 310, 320). In embodiments, the immersive view 350 corresponds to a second generated video stream (e.g., at block 230 of the method shown in FIG. 2). More particularly, the second video stream corresponds to an immersive view of select portions of the first video stream.

In a third portion of method 300, digital pan, tilt, and/or zoom functionality may be performed by moving a virtual camera (or a viewer's “eye”), for example, to adjust a view of the immersive view 350.

In embodiments, data in the 3-D texture cube 300 can be referenced by a spherical coordinate system, where each point, S, on the cube is defined by a pan and tilt angle from the center of the cube. The panoramic view 340 may be the result of applying the panoramic transform, Tₚ, to each view point, Vₚ(x,y), in the panoramic image to get a spherical coordinate, S(pan,tilt), that can be used to look up a color value from the video in the 3-D texture cube.

Vₚ*Tₚ=S

Likewise, in embodiments the immersive view 350 may be determined by the immersive transform, Tᵢ.

Vᵢ*T_{L}=S

Since the spherical coordinate system is common to both views (i.e., the panoramic and immersive views), points in one view (e.g., the panoramic view) can be mapped into the other view (e.g., the immersive view) by using the spherical coordinate system as an intermediary and applying the reverse projection transform.

Vᵢ=S*Tᵢ⁻¹=Vₚ*Tₚ*Tᵢ⁻¹

And conversely,

Vₚ=S*Tₚ⁻¹=Vᵢ*Tᵢ*Tₚ⁻¹

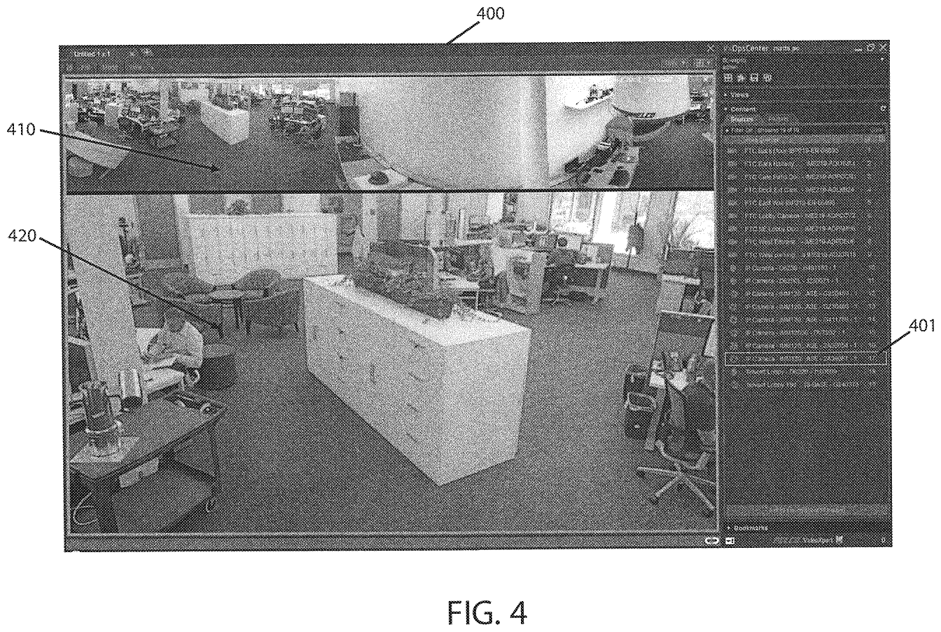

In embodiments, the foregoing math allows a user to click on a point (or area) in the panoramic view 340, and center the corresponding immersive view 350 onto that point. In embodiments, the immersive area tracking feature disclosed herein leverages the same math (or substantially similar math) by mapping points around the perimeter of the immersive view into the panoramic view, and then connecting the resulting points together to form a line drawing. In embodiments, the apparent curvature in the overlay (e.g., 430, shown in FIG. 4, as will be discussed below) is simply the result of mapping enough points along the edge of the immersive view, that the resulting line drawing approximates the true curve.

Referring to FIG. 4, in embodiments the panoramic view (e.g., 340, shown in FIG. 3) and the immersive view (e.g., 350, shown in FIG. 3) may be displayed simultaneously on a display interface 400 of a remote display device (e.g., 150, shown in FIG. 1). In the example embodiment shown, a first video stream 410 corresponding to the panoramic view is displayed in a first viewing area of the display interface, and a second video stream 420 corresponding to the immersive view is displayed in a second viewing area of the display interface.

In embodiments, the display interface 400 is capable of showing scenes captured by a plurality of video surveillance camera devices, for example, by a user selecting one or more cameras (or surveillance areas associated with the cameras) in a portion 401 of the display interface 400.

As illustrated in FIG. 4, the panoramic view depicted by first video stream 410 provides context by showing an entire scene (e.g., 360° scene) captured by at least one camera device at once, while the immersive view depicted by second video stream 420 can be used to zoom in on small details (e.g., objects) within the panoramic view. However, it can sometimes be challenging to understand exactly where the immersive view is looking relative to the larger scene (e.g., the 360° scene) shown by the panoramic view. Referring now also to FIG. 5, to address this issue, an overlay 430 is provided on the panoramic view depicted by first video stream 410 to indicate a current viewing area of the associated immersive view depicted by second video stream 420.

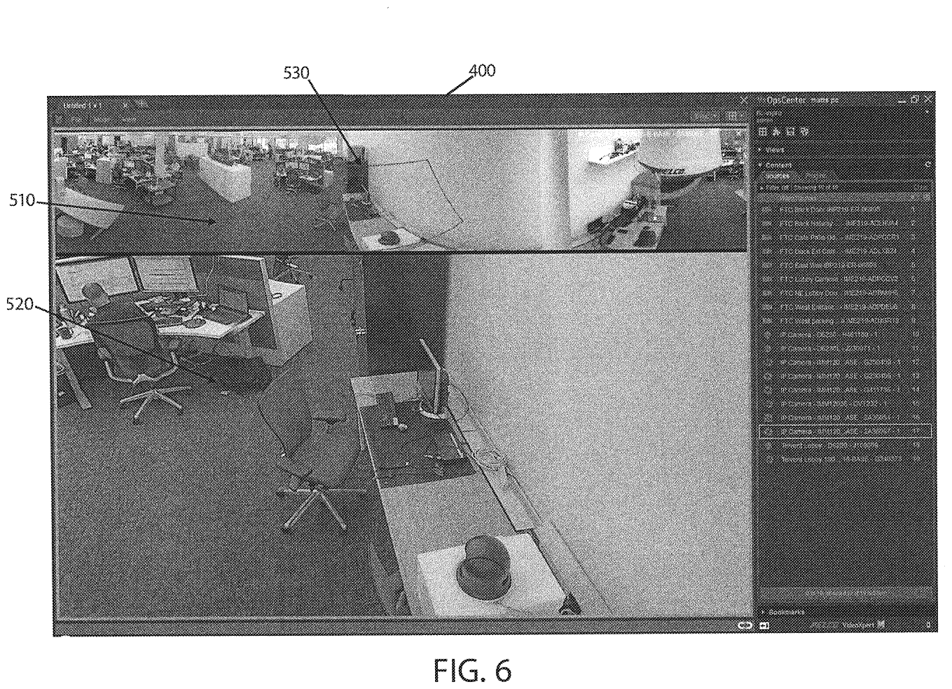

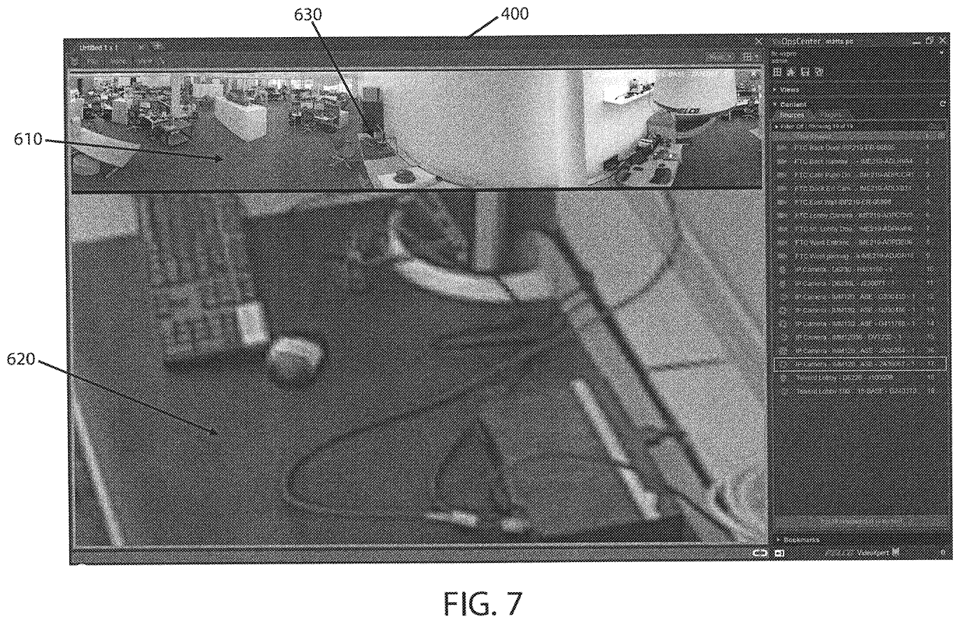

As the immersive view's digital PTZ view changes, for example, the immersive view's position is continuously tracked within the panoramic view, as shown in FIGS. 6 and 7. In FIG. 6, an overlay 530 is provided in a first video stream 510 corresponding to a panoramic view associated with the immersive view depicted by a second video stream 520. Additionally, in FIG. 7, an overlay 630 is provided in a first video stream 610 corresponding to a panoramic view associated with the immersive view depicted by a second video stream 620.

In embodiments, the overlay has an associated shape (or curvature), and the curvature of the overlay may be more pronounced, for example, depending on where the immersive view is pointed. In embodiments, this is a natural result of the map projection, which non-linearly stretches the data, just as a 2-D map of the world will stretch the polar regions more than the equatorial regions.

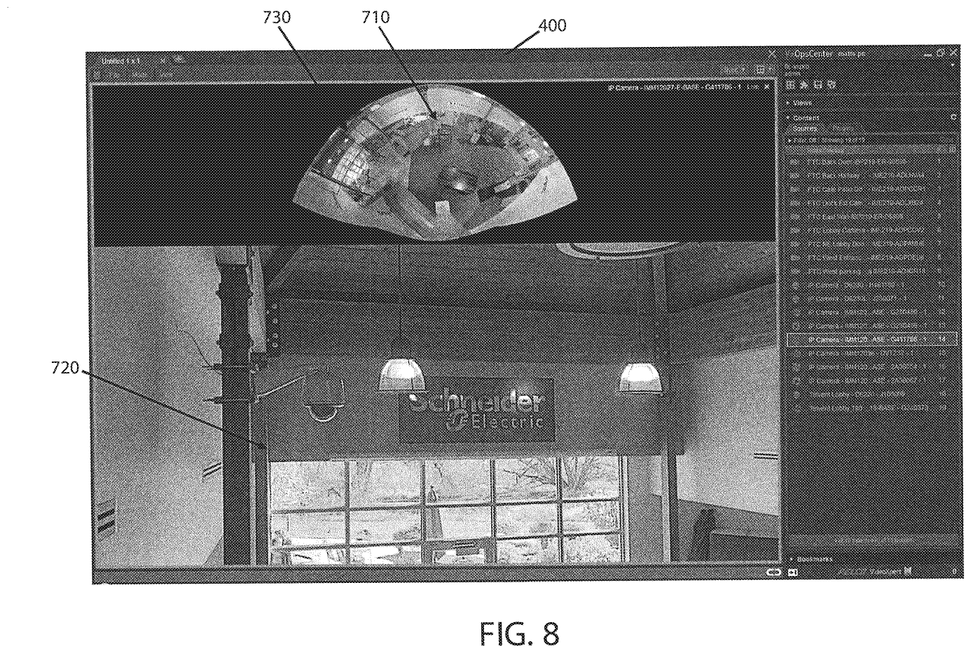

Referring to FIG. 8, display interface 400 shows how the same techniques discussed above may be applied to at least one camera device having a field of view of about two-hundred seventy degrees, for example. An overlay 730 is provided in a first video stream 710 corresponding to a panoramic view associated with an immersive view depicted by a second video stream 720. As illustrated, a somewhat different map projection is used for the at least one camera device having a field of view of about seventy degrees, for example, compared to at least one camera devices having fields of view of about one-hundred eighty degrees or about three-hundred sixty degrees (e.g., as shown in figures above). In embodiments, a cylindrical projection is used for cameras having a field of view of about one-hundred eighty degrees, and for cameras having a field of view of about three-hundred sixty degrees. Additionally, in embodiments for cameras having a field of view of about two-hundred seventy degrees, the cylindrical projection may be modified in order to favor the downward looking direction of the camera over the horizontal directional. That is, instead of preserving the aspect ratios at the horizon at the expense of the “south pole”, the opposite is done so that it shows a better view of the area below the camera, at the expense of the horizontal area of the view. It is understood that a multitude of possible projections exist, and the systems and methods disclosed herein are not limited to any particular projection.

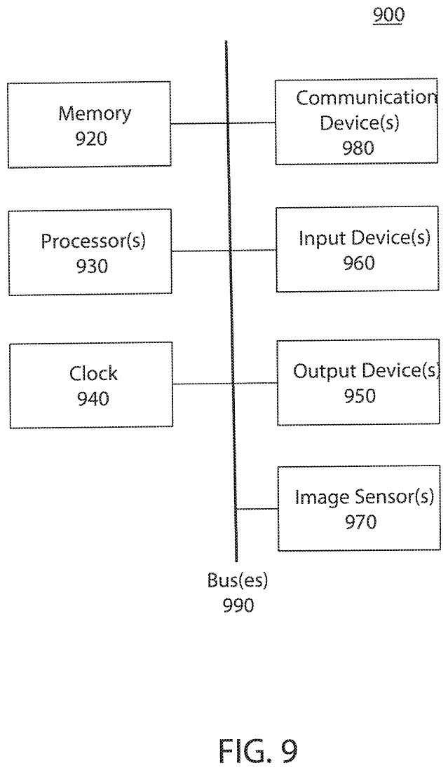

FIG. 9 a block diagram of example components of a computer device (or system) 900, in accordance with an exemplary embodiment of the present disclosure. As shown in FIG. 9, a computer device 900 can include for example memory 920, processor(s) 930, clock 940, output device 950, input device 960, image sensor(s) 970, communication device 980, and a bus system 1090 between the components of the computer device. The clock 940 can be used to time-stamp data or an event with a time value.

The memory 920 can store computer executable code, programs, software or instructions, which when executed by a processor, controls the operations of the computer device 900, including the various processes described herein. The memory 920 can also store other data used by the computer device 900 or components thereof to perform the operations described herein. The other data can include but is not limited to images or video stream, locations of the camera devices, overlay data including parameters, AMO criteria including types of AMOs and priority of different types of AMOs, thresholds or conditions, and other data described herein.

The output device(s) 950 can include a display device, printing device, speaker, lights (e.g., LEDs) and so forth. For example, the output device(s) 950 may output for display or present a video stream(s) in one or more viewers, graphical user interface (GUI) or other data.

The input device(s) 960 can include any user input device such as a mouse, trackball, microphone, touch screen, a joystick, control console, keyboard/pad, touch screen or other device operable by a user. The input device 960 can be configured among other things to remotely control the operations of one or more camera devices or virtual cameras, such as pan, tilt and/or zoom operations. The input device(s) 960 may also accept data from external sources, such other devices and systems.

The image sensor(s) 970 can capture images or video stream, including but not limited to a wide view or a panoramic view. A lens system can also be included to change a viewing area to be captured by the image sensor(s).

The processor(s) 930, which interacts with the other components of the computer device, is configured to control or implement the various operations described herein. These operations can include video processing; controlling, performing or facilitating object detection and tracking, such as for AMOs, in an image or video stream; performing textured mapping of video data onto a 3-D model surface to produce a textured 3-D model; generating one or more video streams of different views of the textured 3-D model including a panoramic view and an immersive view; providing an overlay, which indicates a position of a viewing area of an immersive view, on the panoramic view; transmitting and receiving images or video frames of a video stream or other associated information; communicating with one or more camera devices; controlling or facilitating the control over the operations of one or more cameras devices or virtual cameras; or other operations described herein.

The above describes example components of a computer device such as for a computer, server, camera device or other data processing system or network node, which may communicate with one or more camera devices and/or other systems or components of video surveillance system over a network(s). The computer device may or may not include all of the components of FIG. 9, and may include other additional components to facilitate operation of the processes and features described herein. The computer device may be a distributed processing system, which includes a plurality of computer devices which can operate to perform the various processes and features described herein.

It is to be appreciated that the concepts, systems, circuits and techniques sought to be protected herein are not limited to use in the example applications described herein (e.g., commercial surveillance applications) but rather, may be useful in substantially any application where it is desired to track a viewing area of a camera device.

A processor(s) or controller(s) as described herein can be a processing system, which can include one or more processors, such as CPU, GPU, controller, FPGA (Field Programmable Gate Array), ASIC (Application-Specific Integrated Circuit) or other dedicated circuitry or other processing unit, which controls the operations of the devices or systems, described herein. Memory/storage devices can include, but are not limited to, disks, solid state drives, optical disks, removable memory devices such as smart cards, SIMs, WIMs, semiconductor memories such as RAM, ROM, PROMS, etc. Transmitting mediums or networks include, but are not limited to, transmission via wireless communication (e.g., Radio Frequency (RF) communication, Bluetooth®, Wi-Fi, Li-Fi, etc.), the Internet, intranets, telephone/modem-based network communication, hard-wired/cabled communication network, satellite communication, and other stationary or mobile network systems/communication links. Video may streamed using various protocols, such as for example HTTP (Hyper Text Transfer Protocol) or RTSP (Real Time Streaming Protocol) over an IP network. The video stream may be transmitted in various compression formats (e.g., JPEG, MPEG-4, etc.)

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method, comprising:
receiving video data from at least one camera device;
generating a first video stream corresponding to a panoramic view of imagery associated with the video data, and a second video stream corresponding to an immersive view of select portions of the first video stream;
presenting the first video stream in a first respective viewing area of a remote display device, and the second video stream in a second respective viewing area of the remote display device;
controlling a viewing area of the immersive view; and
providing an overlay on the presented first video stream to indicate the viewing area of the immersive view on the panoramic view.

2. The method of claim 1, further comprising:
identifying one or more objects of interest in the second video stream, wherein controlling the viewing area of the immersive view includes controlling the viewing area of the immersive view to focus on the identified objects of interest.

3. The method of claim 1, wherein one or more properties associated with the overlay are user configurable.

4. (canceled)

5. The method of claim 1, wherein providing an overlay comprises:
mapping points around a perimeter of the immersive view into the panoramic view; and
generating the overlay on the presented first video stream according to the mapped points.

6. The method of claim 1, wherein the overlay corresponds to a line surrounding edges of the viewing area of the immersive view.

7. (canceled)

8. The method of claim 1, wherein the video data corresponds to two-dimensional (2-D) video data, and generating the first video stream comprises copying the 2-D video data onto respective faces of a three-dimensional (3-D) texture cube, and projecting the 3-D texture cube onto a viewing surface, where a viewer's “eye” is placed at a center portion of the 3-D texture cube.

9. The method of claim 1, wherein controlling the viewing area of the immersive view comprises adjusting pan, tilt and/or zoom parameters associated with the immersive view.

10. The method of claim 1, wherein the first video stream is generated from video data associated with a wide field of view camera, and the second video stream is generated from video data associated with a pan-tilt-zoom (PTZ) camera.

11. The method of claim 1, wherein a position of the immersive view is continuously tracked within the panoramic view using the overlay.

12. A system comprising:
memory; and
one or more processors configured to:
receive video data captured from at least one camera device;
generate a first video stream corresponding to a panoramic view of imagery associated with the video data, and a second video stream corresponding to an immersive view of select portions of the first video stream;
present the first video stream in a first respective viewing area of a remote display device, and the second video stream in a second respective viewing area of the remote display device, control a viewing area of the immersive view; and
provide an overlay on the presented first video stream to indicate the viewing area of the immersive view on the panoramic view.

13. The system of claim 12, wherein the one or more processors are configured to: identify one or more objects of interest in the second video stream, wherein the one or more processors are configured to control the viewing area of the immersive view to focus on the identified objects of interest.

14. The system of claim 12, wherein one or more properties associated with the overlay are user configurable.

15. (canceled)

16. The system of claim 12, wherein, to provide an overlay, the one or more processors are configured to:
map points around a perimeter of the immersive view into the panoramic view; and
generate the overlay on the presented first video stream according to the mapped points.

17. The system of claim 12, wherein the overlay corresponds to a line surrounding edges of the viewing area of the immersive view.

18. (canceled)

19. The system of claim 12, wherein the video data corresponds to two-dimensional (2-D) video data, and wherein, to generate, the one or more processors are configured to copy the 2-D video data onto respective faces of a three-dimensional (3-D) texture cube, and project the 3-D texture cube onto a viewing surface, where a viewer's “eye” is placed at a center portion of the 3-D texture cube.

20. The system of claim 12, wherein the viewing area of the immersive view is controlled by adjusting pan, tilt and/or zoom parameters associated with the immersive view.

21. The system of claim 12, wherein the first video stream is generated from video data associated with a wide field of view camera, and the second video stream is generated from video data associated with a pan-tilt-zoom (PTZ) camera.

22. The system of claim 12, wherein a position of the immersive view is continuously tracked within the panoramic view using the overlay.

23. A non-transitory tangible computer-readable medium storing computer executable code, which when executed by one or more processors, is configured to implement a method comprising:
receiving video data from at least one camera device; generating a first video stream corresponding to a panoramic view of imagery associated with the video data, and a second video stream corresponding to an immersive view of select portions of the first video stream;
presenting the first video stream in a first respective viewing area of a remote display device, and the second video stream in a second respective viewing area of the remote display device;
controlling a viewing area of the immersive view; and
providing an overlay on the presented first video stream to indicate the viewing area of the immersive view on the panoramic view.
